(19) United States
(12) Patent Application Publication
(10) Pub. No.: US 2011/0150750 A1
(43) Pub. Date: Jun. 23, 2011

(54) CALCINATION METHOD AND SYSTEM

(75) Inventors: Volker Goecke, Kakerbeck (DE); Peter Hilgraf, Hamburg (DE)

(73) Assignee: Claudius Peters Technologies GmbH, Buxtehude (DE)

(21) Appl. No.: 12/991,083

(22) PCT Filed: May 11, 2009
(86) PCT No.: PCT/EP09/03321

§ 371 Date: Dec. 30, 2010

(30) Foreign Application Priority Data
May 9, 2008 (EP) 08008734.9

(51) Int. Cl. C01F 11/46; B01J 19/00

(52) U.S. Cl. 423/555; 422/187; 422/129

(57) ABSTRACT

A method for the calcination of powdery or fine-particled plaster includes steps in which the plaster is subjected to a flash-calcination in a calcinator and then post-calcinated in a reaction vessel. The post-calcination is carried out in the reaction vessel by adding humid gas, the reaction vessel not being heated. This post-calcination takes place over a long period of time, that is at least 10 times, preferably 50-100 times longer than, the amount of time taken for flash calcination. Complete calcination can take place without expending additional energy, and the remaining dihydrate produced during the flash calcination is also transformed into semi-hydrate and undesired anhydrite fractions are reduced. The method ensures consistency in the product quality and also increases product quality. The temperature in the upstream calcinator can be lowered to save energy. The method can also be used to accelerate the ageing of calcined plaster.

### REFERENCE TO RELATED APPLICATION

This application is the national stage under 35 USC 371 of International Application No. PCT/EP2009/003321, filed May 11, 2009, which claims the priority of European Patent Application No. 08 008 734.9, filed May 9, 2008, the entire contents of which are incorporated herein by reference.

### FIELD OF THE INVENTION

The invention relates to a method for calcining powdery or fine-grained gypsum, the gypsum first being calcined in a calcining mill before it is post-calcined in a reaction vessel. An installation for carrying out these methods and a retrofit reactor are likewise the subject of the invention.

### BACKGROUND OF THE INVENTION

For calcining gypsum, the raw material is comminuted and, after drying (separation of free water), calcined in a reactor (separation of crystalline-bound water). For this purpose, the actual reactor may be preceded by a simple dryer with a burner (DE 37 38 301 A1) or complex fluidized bed dryers (DE 37 21.421 A1). Gypsum burning ovens or rotary kilns are often used as the reactor. An alternative way of performing the process envisages combining the comminuting and the calcining in a special calcining mill. The latter type of design offers advantages with regard to energy utilization and the fineness of the end product. For such a calcining mill, usually a ball/rolling-ring mill or else a hammer mill/HIC (Horizontal Impact Calciner) is used as the grinding unit. In addition, hot gas is supplied, with the aim of converting dihydrate (DH) present in the gypsum as optimally as possible into hemihydrate (HH). To achieve a short dwell time in the calcining mill, its temperature level must lie above the actual calcining temperature. The energy required for such flash calcination is considerable. Furthermore, undesired anhydrite (AIII) is produced in the gypsum.

It is known from methods for producing cement to provide reactors for carrying out a post-calcination. However, the “calcining” of cement is based on an entirely different process than in the case of gypsum (changing the basic chemical structures in the case of cement as opposed to simply separating crystalline-bound water), which is carried out at different temperatures for a different purpose (removing acid constituents in the case of cement as opposed to dewatering in the case of gypsum). In order to reach the required temperatures, dedicated heating is provided for the downstream reactor (US 2007/0248925 A1, DE 32 15 793 A1).

### SUMMARY OF THE INVENTION

The invention addresses the problem of improving the gypsum calcining process in such a way that the same or a higher quality can be achieved while using a lower amount of energy.

The solution according to the invention lies in the features of the independent claims. Advantageous developments are the subject of the dependent claims.

The invention extends to a method for calcining gypsum comprising the method steps of calcining the gypsum in a calcining mill and post-calcining the hot gypsum in a reaction vessel, the calcining being carried out as flash calcination and the post-calcining being performed in the reaction vessel while supplying wet gas, and the reaction vessel otherwise not being heated, and the dwell time being at least 10 times, preferably 50 to 100 times, greater than the dwell time in the case of flash calcination.

One application of the method according to the invention concerns speeding up the aging process of stucco plasters following calcination and cooling down in a downstream reactor, wet gas being fed into the downstream reactor and the dwell time being monitored by a control system. Stucco plaster is understood here as also meaning plastering gypsum.

The invention also relates to arrangements for carrying out the stated methods: on the one hand, a calcining installation comprising a flash calcining mill and a reaction vessel, lying thereafter in the running direction of the process, the reaction vessel having a connection for feeding with, preferably hot, wet gas and otherwise being of a thermally passive design, and a control system being provided, formed for the purpose of setting the gas supply such that the dwell time of the gypsum in the reaction vessel is at least 10 times, preferably 50 to 100 times, greater than the short dwell time in the case of flash calcination; on the other hand, a corresponding retrofit reactor for a calcining installation.

For the purposes of this invention, a component is thermally passive if no outside energy has to be supplied to operate the component; rather, only thermal energy that occurs as lost energy in other stages of the process is supplied. In particular, thermally passive components are therefore distinguished by the absence of heating devices for process heat.

Wet gas is a gas that has a water content of at least 30% (this is a percentage by volume).

Waste system air is gas that occurs as waste air in other stages of the process of the calcining installation; this includes, in particular, waste air of the calcining mill and a cooler. It does not include gas heated by a heating device itself.

The invention is based on a calcining mill in which the gypsum to be calcined is subjected to a comminution process and a calcining process. For this purpose, a comminution stage and a calcining stage are provided, which may also be combined with each other. It is immaterial hereafter whether or not the two stages are combined. The gypsum leaving the calcining mill has in any case passed through both stages.

In the calcining mill, the comminuted gypsum is heated to a temperature of preferably over 150° C., preferably between 150° C. and 160° C., at which the calcining process is initiated, and is calcined for a certain time. The dwell time in the calcining mill is with preference 1 to 10 seconds, preferably 2 to 6 seconds, more preferably 3 seconds. After this very short time (flash calcination), complete calcination is not ensured. When it leaves the calcining mill, the gypsum is only partially calcined and is supplied in this form to the reaction vessel, the gypsum still being in a hot state. The temperature of the gypsum is generally 100° C. or more. Furthermore, the creation of undesired components in the gypsum, in particular an increased fraction of double hydrate and anhydrite (AIII) is unavoidable in flash calcination.

In order to counter these disadvantages that accompany flash calcination, the invention provides an energy-neutral post-calcination in the downstream reaction vessel using the increased temperature of the gypsum, to be precise for a considerably longer period of time. A crucial part is played here by supplying the wet gas, which acts as a reaction gas for the post-calcination (the waste air from the upstream calcining mill is particularly suitable, since it has a water content of over 35% and, at over 150° C., is quite hot). Thanks to the water vapor thereby supplied, both the undesired anhydrite can be rehydrated and any double hydrate that is present can be further converted into hemihydrate.

The invention has recognized that supplying the wet gas is of decisive significance, since the water required for rehydrating the anhydrite is thereby supplied, and together with the thermally passive design there is also sufficient thermal energy available, without heating being required. The undesired fractions in the starting product of the calcining mill can in this way be reduced in an elegant manner and without requiring additional energy. The improvement in product quality is consequently achieved without increased operating costs. Although it is necessary for a sufficiently long dwell time to be maintained, this is not a disadvantage, since no costly energy supply is required.

Thanks to the thermally passive design, the dwell time in the reaction vessel can be chosen to be as long as desired and is preferably 10 to 30 minutes, more preferably 15 to 25, more preferably 20 minutes.

Thanks to the invention, the calcination can be completed without requiring additional energy. The product quality is increased as a result, and consequently no longer restricted by the calcination quality of the calcining mill. The invention isolates the calcination quality of the calcining mill from that of the end product. Consequently, less calcination than in the prior art is adequate in the calcining mill. This means that the temperature there can be lowered, which saves energy; at the same time, the fraction of undesired anhydrite is thereby reduced.

By the post-calcination with a long dwell time in the reaction vessel, the invention also achieves a more uniform product. This not only increases the quality of the calcined gypsum, but also compensates for inflow fluctuations when the raw product is supplied. Fluctuations therefore no longer have adverse effects here on the product quality.

Apart from post-calcination, the reaction vessel also provides mixing-through of the gypsum. For this purpose, the reaction vessel is equipped with at least one fluidizing device. This allows caking or the forming of dead zones in the reactor to be prevented and produces more intensive mixing-through. The wet gas is advantageously used as fluidizing gas. However, it is also possible for this purpose to mix ambient air with the waste system air, in particular originating from the calcining mill. It is assumed hereafter that the supplied gas causes fluidizing of the bulk material. However, it is also possible that the gypsum is merely flowed around by the gas, without the advantages produced by fluid-like mixing being exploited. The mixing-through and the prevention of caking or the forming of dead zones may be achieved in some other way.

The result of the post-treatment can be improved still further if thermal energy in the form of waste system air is supplied to the gypsum in the reaction vessel. Waste air from the upstream calcining mill or the downstream cooler is preferably used here.

The composition of the supplied gas is preferably monitored and controlled. Suitable controlled variables are, for example, the temperature and the water content. Further regulating possibilities are provided by the use of mixers and/or water separators.

The invention also relates to an installation for carrying out the method just described. For an explanation of this installation, reference is made to the description given above.

A further possibility of improving the product quality of gypsum without requiring extra thermal energy is that of speeding up the aging process. In the aging process, the gypsum begins to rehydrate at its surface, i.e. AIII constituents are converted into hemihydrate constituents.

To speed up this process, a post-treatment in a downstream reactor may be provided following calcination and subsequent cooling down. This downstream reactor corresponds to the reaction vessel described above.

The downstream reactor preferably has a fluidizing device, in order to provide good mixing-through of the gypsum. The fluidizing gas may in this case also serve at the same time as reaction gas. For this purpose, reaction promoters or reaction inhibitors may be added to the gas as required. The reaction gas may otherwise also be introduced into the downstream reactor separately from the fluidizing gas.

No thermal energy is specifically generated for the operation of the downstream reactor. The thermal energy that occurs as lost energy during the calcining process is used for its operation. However, supplying the downstream reactor with lost energy from other processes is not ruled out.

The temperature of the waste gas is preferably over 150° C. and more preferably up to 160° C. A temperature control may be provided, formed for the purpose of controlling the temperature in the downstream reactor by mixing in cooler gas, such as ambient air. The cooler gas may be mixed in here with the waste gas or be supplied to the downstream reactor directly. The temperature control is preferably further formed for the purpose of appropriately setting the water content of the gas in the downstream reactor.

An arrangement suitable for carrying out this method is likewise the subject of this invention. For explanation, reference is made to the statements made above with respect to the associated method.

In order to ensure a consistently high product quality, the stated methods are preferably performed under computer control. For this purpose, corresponding measuring sensors and computing units are provided.

A retrofit reactor for calcining installations for carrying out this method is likewise the subject of this invention. The retrofit reactor comprises a supplying device for at least partially calcined hot gypsum, a reaction chamber and a discharging device for the fully calcined gypsum, the invention providing that the retrofit reactor is of a thermally passive design and a connection for feeding wet gas, preferably hot wet gas, into the reaction chamber is provided on it, and that a control system is provided, formed for the purpose of controlling the dwell time of the gypsum in the reaction chamber by metering the supplied amount of wet gas and/or the discharging device. For explanation, reference is made to the statements made with respect to the method described above.

### BRIEF DESCRIPTION OF THE DRAWINGS

The invention is explained in more detail below with reference to the accompanying drawing, in which advantageous exemplary embodiments are represented and in which:

FIG. 1 shows a schematic overview of an exemplary embodiment of a calcining installation;

FIG. 2 shows a sectional view of a reactor vessel of the calcining installation according to FIG. 1; and

FIG. 3 shows a schematic overview of an exemplary embodiment of an installation for speeding up the aging process of stucco plasters.

### DETAILED DESCRIPTION OF THE INVENTION

The device will be explained on the basis of an exemplary embodiment of an installation for calcining gypsum. Raw material for the gypsum to be calcined is introduced into the calcining installation at a charging point 1. The raw material may be, in particular, recycled gypsum products, such as gypsum building boards, and also so-called FGD gypsum from flue gas desulfurization installations (FGD). The application area of the invention is not only restricted to such gypsum but also extends to other types of synthetic gypsum, in particular phosphorus gypsum; however, natural gypsum may also be used. From the charging point 1, the gypsum raw material passes to an upper end of a storage silo 2. This is arranged in an elevated position and is located above a calcining mill 3.

The material to be calcined—in this case gypsum—is introduced via a line 12 into the calcining mill 3. In the calcining mill 3, the gypsum is comminuted and calcined. The calcination is performed as flash calcination. This means there is a short dwell time of less than 10 seconds at a temperature of 150° C. to 160° C., that is to say above the actual calcining temperature. For this purpose, a hot-gas generator 31 is connected to the calcining mill 3 via a supply line 32.

Once flash calcination has been performed for a dwell time of, for example, only 3 seconds (which according to the invention need not be complete), the still hot gypsum, at over 100° C., is sent via a rising line 13 from the calcining mill 3 to a filter installation 5. From there, a line 15 leads to a reaction vessel 6 according to the invention. It stays there for 20 minutes, and in this time is post-calcined without outside energy being supplied. The operating mode of the uncooled reaction vessel 6 will be described in more detail. From the reaction vessel 6, the still hot gypsum is transported via a line 16 to a charging end of a rotary cooler 7. After passing through the cooler 7, the cooled and by then completely calcined gypsum is passed via a distributing line 17 into a storage silo 19. It can be removed from this according to requirements. For the removal of waste heat, an installation for waste system air 4 is provided. The calcining mill 3, the filter 5 and the cooler 7 are connected to it.

Furthermore, a mixer 40 is connected to the waste system air 4. Hot waste air at a temperature of over 150° C. is supplied via a line 43 from the calcining mill 3 and via a line 47 from the cooler 7. A line 41 is provided for supplying ambient air, in order in this way to supply ambient air as and when required to lower the temperature of the waste air. The mixture thereby produced passes to a water separator 44. In this water separator 44, moisture may either be extracted from the gas mixture or added to it, according to requirements. The moist mixture treated in this way is supplied as reaction gas, and possibly fluidizing gas, through the line 49 to a wet gas connection 69 on the reaction vessel 6.

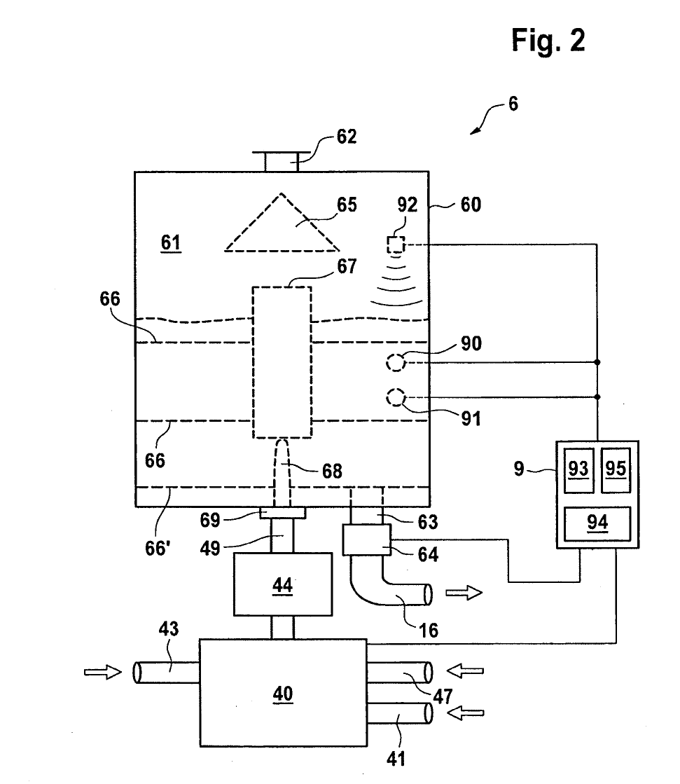

An exemplary embodiment of the downstream reactor 6 is represented in more detail in FIG. 2. The downstream reactor 6 is designed for a throughput of about 35 m³ per hour. It comprises as main components a housing 60, which encloses a working chamber 61, and a supplying device 62, which is arranged at the upper end and into which the supply line 15 is connected, and a discharging device 63, which is arranged at the lower end and transports the by then completely calcined gypsum away via a line 16. In the exemplary embodiment represented, the housing 60 is of a cylindrical shape with a diameter of approximately 3 meters, the supplying device 62 being arranged in an upper end wall and the discharging device 63 being arranged in a lower end wall, the bottom. The height is approximately 5 meters. Inside the likewise cylindrical working chamber 61, a number of fluidizing trays 66 are arranged in a horizontal direction. The fluidizing trays 66 substantially comprise a tray with hollow chambers arranged thereunder for supplying fluidizing gas, which can emerge upwards through openings in the fluidizing tray 66, and thereby flows through and fluidizes a layer of the material to be treated that is resting on the fluidizing tray 66. Arranged at the lower end of the working chamber 61 is a further fluidizing tray 66′, which additionally has apertures for the connection of the discharging device 63.

In the upper region of the working chamber 61 there is a dispersion element 65 directly below the supplying device 62 in the direction of fall. Said element is designed as a cone. Its axis lies coaxially in relation to the axis of the cylindrical working chamber 61, the apex pointing upwardly toward the supplying device 62. Supplied gypsum falls in its falling motion onto the conical lateral surface of the cone 65, and, thanks to the rotationally symmetrical shaping, is thereby uniformly diverted radially in all directions.

Provided below the cone 65 in the axis of the cylindrical working chamber 61 is a rising pipe 67, extending from the bottom upward. This is arranged such that it passes through the two fluidizing trays 66. The rising pipe has a metallic pipe jacket, which has a free cross section of 60 cm. The length of the rising pipe 67 is approximately 3 meters, its lower end being arranged approximately 50 cm above the bottom of the working chamber 61. Provided in the bottom of the housing 60, in the axis and below the rising pipe 67, is a central nozzle 68, to which the gas mixture supplied from the mixer 40 via the wet gas connection 69 is supplied. The nozzle 68 directs its gas stream into the rising pipe 67, whereby the static pressure drops there and a circulating motion forms in the working chamber. The gas mixture flowing over the free space within the nozzle 68 and in the rising pipe entrains particles of the material from the ambience, whereby the entrained particles of the material are transported back into the upper region, into the working chamber 61 above the fluidizing trays 66. This has the effect of forming a circulating motion, by the material that is moving downward via the fluidizing trays 66 in the outer region of the working chamber 61 being transported upward again by means of the rising pipe 67 and the stream of waste gas supplied to it. This circulating motion allows effective post-calcination to be achieved, utilizing the moisture of the gas mixture and the residual heat of the material entering via the supplying device 62.

Arranged in the bottom of the housing 60 is the discharging device 63 with outlet points. The outlet points comprise an actuator 64 for closing or opening the outlet point. The actuator 64 is connected to a control system 9.

Instead of the fluidizing tray 66, a different type of fluidizing device may also be provided. As described above, the waste gas is preferably used for the fluidizing, but ambient air or some other gas may also be used for the fluidizing.

The control system 9 comprises a temperature monitoring module 93, a moisture module 95 and a dwell time module 94. Arranged on the reaction vessel 6 are sensors, a temperature sensor 90, a moisture sensor 91 and a radar level sensor 92, which are connected to the control system 9. The control system 9 computationally combines the measured values and acts on the mixer 40. The dwell time module 94 also regulates the supplies for the wet gas or the fluidizing air and the actuators 64 for the discharge of the material. The temperature and moisture module 93, 95 is formed for the purpose of determining the temperature and moisture in the reaction vessel 6 via the temperature sensor 90 and the moisture sensor 91. To increase the temperature, waste system air 4 is supplied and, to lower the temperature, ambient air is supplied. If in this case the moisture is to be increased, moist waste air from the calcining mill 3 is added, or reliance is placed on drier waste air from other stages of the process, in particular the cooler 7. This achieves the effect that the gypsum coming from the calcining mill 3 is post-calcined in a monitored manner using its own heat and that of the waste gas supplied to it. Only partially calcined gypsum is post-calcined by the calcining mill 3, that is to say the conversion from dihydrate to hemihydrate is completed, and any anhydrite (AIII) that is present becomes hemihydrate.

By means of the radar level sensor 92, the control system 9 activates the discharging device 63 such that the filling level and the dwell time of the material in the reaction vessel 6 are regulated.

In this way it is possible to achieve a more uniform and improved quality of the calcined gypsum. On the one hand, greater uniformity is obtained by compensating for brief fluctuations thanks to the buffering achieved by the holding time in the working chamber 61. Furthermore, a reduction of undesired soluble anhydrite fractions and of dihydrate fractions is obtained. Another considerable advantage lies in the reduction of energy costs by using the heat of the material after the comminuting or calcining stage 3 for continuing the calcining process in the reaction vessel 6. Finally, yet another advantage lies in the possibility of regulating the water and gypsum value, setting time and residual water of crystallization by controlling the dwell time in the working chamber 61, as well as possibly by controlling the supply of water vapor.

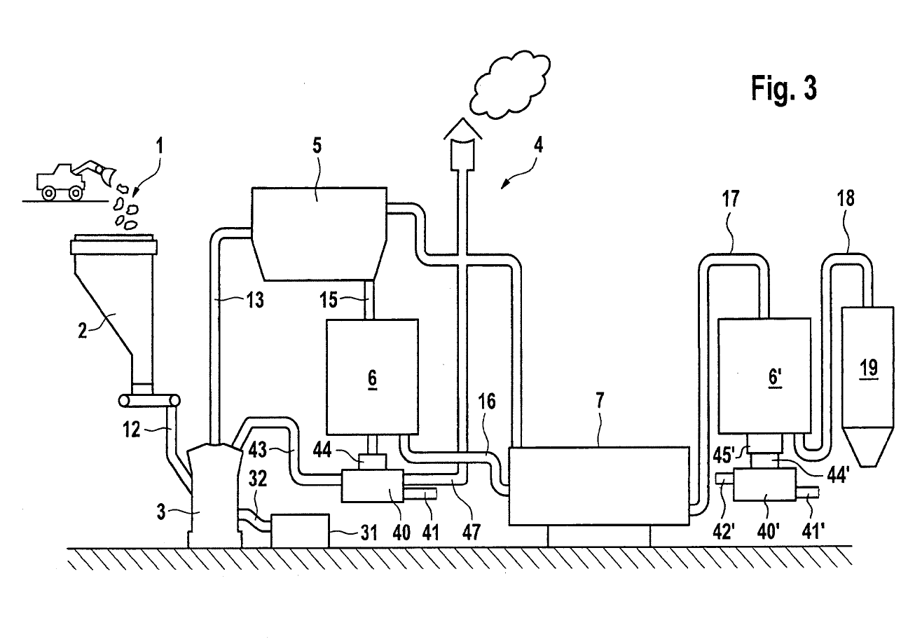

An installation for speeding up the aging process of stucco plasters is represented in FIG. 3.

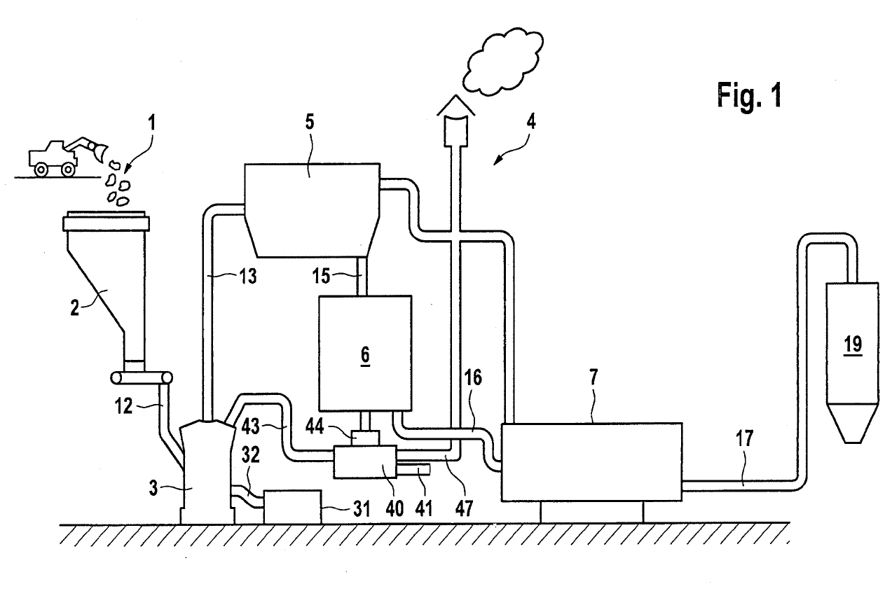

The installation corresponds substantially to the installation represented in FIG. 1. Unless otherwise explained below, the same elements bear the same reference numerals and have the same functions as explained in conjunction with FIG. 1.

Arranged between the cooler 7 and the storage silo 19 is a downstream reactor 6′. Its construction corresponds substantially to that of the reaction vessel 6. Once calcining and cooling have been performed, the material is supplied via the line 17 to the downstream reactor 6′ to bring about aging, before it is transported away via a line 18 to the storage silo 19. It should be noted that the aging does not necessarily have to take place in the downstream reactor 6′ arranged after the cooler 7, but may also take place in the reaction vessel 6 arranged before the cooler 7. Conversely, if the downstream reactor 6′ is used, the reaction vessel 6 may be omitted.

The waste system air 4 that is produced during the calcining process and preferably has a temperature of over 150° C. is supplied via a line 42′ to a mixer 40′. There, it is mixed with air via the ambient air line 41′ according to requirements, in order in this way to lower the temperature. The waste air flows into the water separator 44′, where its water content can be adapted. Furthermore, it flows into a decontamination chamber 45′. There, the gas mixture is mixed with additional substances, in order to be able to improve further the product quality of the gypsum.

The waste gas then passes into the downstream reactor 6′, where it is preferably used as fluidizing gas and reaction gas. However, it may also be envisaged to supply the waste air just as reaction gas and to use another gas, for example ambient air, for the fluidizing.

1-17. (canceled)

18. A method for calcining powdery or fine-grained gypsum, comprising
flash calcining gypsum in a calcining mill to produce hot calcined gypsum and
post-calcining the hot gypsum in a reaction vessel,
wherein the post-calcining is performed in the reaction vessel while supplying a wet gas, the reaction vessel otherwise not being heated, and the dwell time in the post-calcining being at least 10 times greater than the dwell time in the flash calcination.

19. The method of claim 18, wherein the dwell time in the post-calcination is 50 to 100 times greater than the dwell time in the flash calcination.

20. The method of claim 18, wherein the flash calcination is performed with a dwell time of 1 to 10 seconds, more preferably 2 to 6 seconds.

21. The method of claim 18, wherein the flash calcination is performed with a dwell time of 2 to 6 seconds.

22. The method of claim 18 or 20, wherein the dwell time of the gypsum in the reaction vessel is 10 to 30 minutes.

23. The method of claim 18 or 20, wherein the dwell time of the gypsum in the reaction vessel is 15 to 25 minutes.

24. The method as claimed in claim 18 or 20, wherein the wet gas is supplied to a fluidizing device in the reaction vessel.

25. The method, of claim 18 or 20, wherein the wet gas is cooled down by a mixer with ambient air before being supplied to the reaction vessel.

26. The method of claim 25, wherein the mixer sets the water content supplied to the reaction vessel.

27. The method of claim 18 or 20, wherein the gypsum is dried before the flash calcining.

28. The method of claim 18 or 20, wherein the reaction vessel is operated with a density of the gypsum that is at least twice as high as that in the calcining mill.

29. The method of claim 18 or 20, further comprising introducing reaction promoters or reaction inhibitors into the reaction vessel.

30. A calcining installation, comprising:
a calcining mill formed for flash calcination with a short dwell time,
a transporting line with a filter installation,
a separate reaction vessel, lying after the transporting line in a running direction of the process and comprising a connection of a thermally passive design provided on the reaction vessel for receiving wet gas, and
a control system for setting the gas supply such that the dwell time of the gypsum in the reaction vessel is at least 10 times greater than the short dwell time in the calcining mill for flash calcination.

31. The calcining installation of claim 30, wherein the dwell time of the gypsum in the reaction vessel is 50 to 100 times the short dwell time in the calcining mill for flash calcination.

32. The calcining installation of claim 30, wherein the control system is configured to act on the gas supply of a fluidizing device in the reaction vessel.

33. The calcining installation of claim 30 or 32, wherein the connection for the wet gas of the reaction vessel is connected to the filter installation as a gas source.

34. The calcining installation of claim 30 or 32, further comprising a mixer for cooling the wet gas supplied to the reaction vessel.

35. The calcining installation of claim 30 or 32, further comprising water separators provided for regulating the water content of the wet gas supplied.

36. The calcining installation of claim 30 or 32, wherein the control system is configured for regulating temperature, water content or filling level in the reaction vessel.

37. A retrofit reactor for a calcining installation comprising:
a supplying device for at least partially calcined hot gypsum,
a reaction chamber for calcining the gypsum,
a discharging device for fully calcined gypsum, and
a control system configured for controlling a dwell time of the gypsum in the reaction chamber by metering the supplied amount of wet gas or the discharging device,
wherein the retrofit reactor is of a thermally passive design and comprises a connection for feeding wet gas into the reaction chamber.

38. The retrofit reactor of claim 37, wherein the retrofit reactor is configured in accordance with the configuration of claim 33.
